(19) United States
(12) Patent Application Publication
(10) Pub. No.: US 2009/0279621 A1
(43) Pub. Date: Nov. 12, 2009

(54) Signal converter and multimedia system using the same

(76) Inventors: Shui-Lai Hsieh, Hsin-Chu City (TW); Chien-Te Wu, Hsin-Chu City (TW)

Correspondence Address: HDLS Patent & Trademark Services, P.O. BOX 220746, CHANTILLY, VA, 20153-0746, US

(21) Appl. No.: 12/118,744

(22) Filed: May 11, 2008

(51) Int. Cl. H04K 1/10

(52) U.S. Cl. 375/260

(57) ABSTRACT

In a signal converter and a multimedia system using the same, the multimedia system includes an image capture device, a first signal converter, a second signal converter. The image capture device is configured for capturing images, converting the images into a first electronic signal, and transmitting the first electronic signal through a first type transmission interface. The first signal converter is configured for receiving the first electronic signal, modulating the first electronic signal by the orthogonal frequency-division multiplexing (OFDM) technology to obtain a second electronic signal suited for a second type transmission interface. The second signal converter is configured for receiving and modulating the second electronic signal through the second type transmission interface. The first type transmission interface is different from the second type transmission interface.

### 1. FIELD OF THE INVENTION

The present invention relates to a multimedia system, and more specifically, to a signal converter and a multimedia system using the same.

### 2. DESCRIPTION OF THE RELATED ART

In information-rich modern society, more and more information are transmitted through various media, instead of mouth-to-ear. For example, manufacturers usually employ static-state billboards, televisions, or TV walls to play advertisement. However, the above methods have many disadvantages. For example, the method of employing billboards is inconvenient for replacing the advertisement. The method of employing TV walls is also inconvenient for replacing the advertisement in some conditions, such as wall-hanging televisions disposed inside or outside of elevators, which play information stored in memory arranged therein.

For solving the above problems, a conventional technology employs internet as a transmission interface to update actively information. However, general 10/100M lines can not be used to transmit signals at long bowls (about 100 meters) without relaying transmission stations. Furthermore, the lines are difficultly set in outdoor. Furthermore, the lines are also difficultly set in buildings or transport devices, such as trains or airplanes. Therefore, a large of money and time will be spent and the methods are inconvenient for being performed.

What are needed are a signal converter and a multimedia system using the same, which can solve the above problems.

### BRIEF SUMMARY

An object of the present invention is providing a signal converter, which can be set on old buildings or old transmission system, and can be used to update information with a low cost.

Another object of the present invention is providing a multimedia system using the signal converter, which can be set on old information transmission system to build a monitoring system.

Other object of the present invention is providing a multimedia system using the signal converter, which can be set on old communicating system to save the cost of updating.

A signal converter, in accordance with a preferred embodiment of the present invention, includes a first transmission interface and a second transmission interface. A first electronic signal suited for the first transmission interface and a second electronic signal suited for the second transmission interface are modulated/demodulated by the orthogonal frequency-division multiplexing (OFDM) technology. The first transmission interface is configured for exchanging information with an image capture device, a display device and a network telephone. The second type transmission interface uses one of coaxial cables, telephone lines and twisted pairwires as a transmission medium.

A multimedia system using the signal converters, in accordance with a preferred embodiment of the present invention, includes an image capture device, a first signal converter, and a second signal converter. The image capture device is configured for capturing images, converting the captured images into a first electronic signal, and transmitting the first electronic signal through a first type transmission interface. The first signal converter is configured for receiving the first electronic signal, modulating the first electronic signal by the orthogonal frequency-division multiplexing (OFDM) technology to obtain a second electronic signal suited for a second type transmission interface. The second signal converter is configured for receiving and modulating the second electronic signal through the second type transmission interface. The first type transmission interface is different from the second type transmission interface.

In a preferred embodiment of the present invention, the first type transmission interface uses RJ-45 lines as a transmission medium. In another preferred embodiment of the present invention, the first type transmission interface uses network protocol, and the multimedia system further includes a radio-signal receiver configured for receiving the first electronic signal and transmitting the first electronic signal to the first signal converter.

In a preferred embodiment of the present invention, the second type transmission interface uses coaxial cables, telephone lines or twisted pairwires as a transmission medium.

In a preferred embodiment of the present invention, the transmission medium used in the second type transmission interface supplies power to the image capture device. Furthermore, the multimedia system further includes a power converter, configured for converting the power on the transmission medium of the second type transmission interface to a power suited for the image capture device.

In a preferred embodiment of the present invention, the image capture device is a network monitoring image capture device, and the multimedia system further includes a multimedia interface device coupled between the image capture device and the first signal converter. The multimedia interface device is configured for converting the first electronic signal sent from the image capture device to an electronic signal suited for the first signal converter.

A multimedia system using the signal converters, in accordance with another preferred embodiment of the present invention, includes a server, a first signal converter, a second signal converter and a display device. The server is configured for supplying multimedia information. The first signal converter is configured for receiving the multimedia information through a first type transmission interface, and modulating the multimedia information to obtain an electronic signal suited for a second type transmission interface. The second signal converter is configured for receiving and demodulating the electronic signal through the second type transmission interface. The display device electrically connects to the second signal converter to display the electronic signal after being demodulated by the second signal converter. The first type transmission interface is different from the second type transmission interface.

The present invention uses the orthogonal frequency-division multiplexing (OFDM) technology to modulate the electronic signal. The modulated electronic signal can be transmitted in the old signal transmitting lines, such as telephone lines, coaxial cables or twisted pairwires. Therefore, the present multimedia system can be set on the old buildings or transport systems to save cost and time.

Other objects, advantages and novel features of the invention will become more apparent from the following detailed description when taken in conjunction with the accompanying drawings, in which:

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a circuit block diagram of a signal converter, in accordance with a preferred embodiment of the present invention;

FIG. 2 is a block diagram of a multimedia system using the signal converter, in accordance with a preferred embodiment of the present invention;

FIG. 3 is a block diagram of a multimedia system using the signal converter, in accordance with another preferred embodiment of the present invention;

FIG. 4 is a block diagram of a multimedia system using the signal converter, in accordance with still another preferred embodiment of the present invention;

FIG. 5 is a block diagram of a multimedia system using the signal converter, in accordance with still another preferred embodiment of the present invention;

FIG. 6 is a block diagram of a multimedia system using the signal converter, in accordance with still another preferred embodiment of the present invention;

FIG. 7 is a block diagram of a multimedia system using the signal converter, in accordance with still another preferred embodiment of the present invention; and

FIG. 8 is a block diagram of a multimedia system using the signal converter, in accordance with still another preferred embodiment of the present invention.

### DETAILED DESCRIPTION

Reference will now be made to the drawings to describe a preferred embodiment of the present film thermoforming method, in detail.

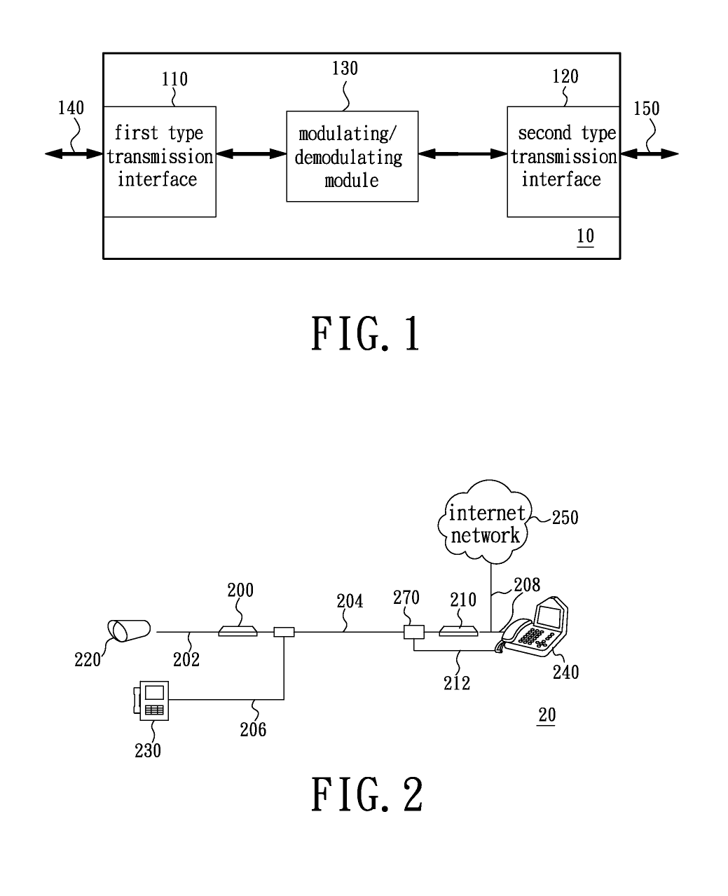

Referring to FIG. 1, a circuit block diagram of a signal converter 10 in accordance with a first preferred embodiment of the present invention is shown. In this exemplary embodiment, the present signal converter 10 includes a first type transmission interface 110, a second type transmission interface 120 and a modulating/demodulating module 130. The first type transmission interface 110 is communicated to an external device through a first transmission medium 140. The external device may be a terminal device, such as image capture device, multimedia display, or net phone. The second type transmission interface 120 is communicated to other signal converters through the second transmission medium 150. In this exemplary embodiment, the second transmission medium 150 may be telephone lines, coaxial cables, or twisted pairwires. Furthermore, the modulating/demodulating module 130 employs the orthogonal frequency-division multiplexing (OFDM) technology to modulate/demodulate the signals.

Referring to FIG. 2, a block diagram of a multimedia system using the signal converter as shown in FIG. 1 is provided. In this exemplary embodiment, the multimedia system 20 includes two signal converters 200 and 210, a network monitoring image capture device 220, a conventional telephone 230, and a network telephone 240 having functions of the conventional telephone and the network telephone. In this exemplary embodiment, the network monitoring image capture device 220 converts monitoring images into electronic signals, and transmits the electronic signals to the signal converter 200 through a transmission medium 202 (such as RJ-45 network line). The signal converter 200 employs the orthogonal frequency-division multiplexing technology to modulate the electronic signals, and transmits the modulated electronic signals to the signal converter 210 through a frequency divider 270 and a transmission medium 204 (such as telephone line). The signal converter 210 receives the modulated electronic signals after through the transmission medium 204 and the frequency divider 270 to demodulate the modulated electronic signals, and transmits the demodulated electronic signal to the network telephone 240 or internet network 250 for displaying or other using through a transmission medium 208 (such as RJ-45 network line). Thus, when the internet network 250 is communicated with a display device, the display device can update actively information. The present method is also convenient for just in-time monitoring or commercial call.

Furthermore, the conventional telephone 230 (may be telephone extension used in doorway of company) and the network telephone 240 may be communicated with other devices of the multimedia system 20 through the telephone lines 206 and 212 to use the transmission medium 204 for transmitting speech information.

Since the multimedia system 20 employs the telephone 204 to transmit the electronic signals, the multimedia system can be used in used telephone systems, thus the cost can be saved for reset new network lines.

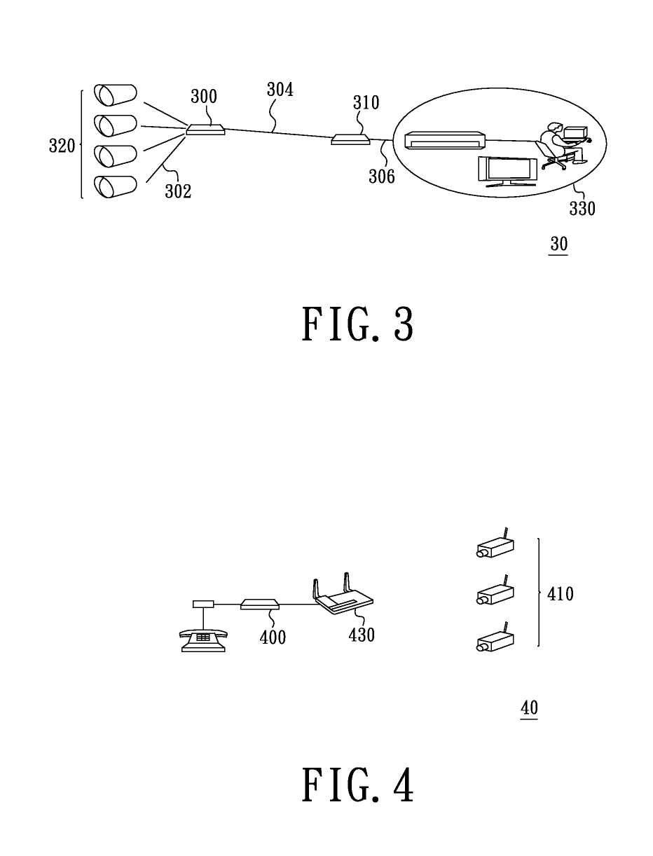

Referring to FIG. 3, a block diagram of a multimedia system in accordance with another preferred embodiment of the present invention is shown. In this exemplary embodiment, the multimedia system 30 includes two signal converters 300 and 310, a network monitoring image capture module 320 and a monitoring system 330. The signal converter 300 may receives synchronously electronic signals from a plurality of network monitoring image capture devices of the network monitoring image capture module 320. Similar to the above embodiment, the transmission medium 304 between the two signal converters 300 and 310, may be telephone lines, coaxial cables, or twisted pairwires. The transmission medium 302 between the signal converter 300 and the network monitoring image capture module 320, and between the signal converter 310 and the monitoring system 330, may be general network lines.

Furthermore, due to the fact, if the network monitoring image capture device has analog signal output terminals, the analog signals outputting from the analog signal output terminals may be modulated by a suited modulator, and transmitted in the transmission medium 304 by adding a mixer. Thus the signal receiver in the monitoring system 330 may receive directly the needed signal from the transmission medium 304 for the following displaying or monitoring.

The multimedia system 30 may be used through the telephone lines, coaxial cables or twisted pairwires, thus it is simple for updating the information of the whole monitoring system in the old buildings.

Referring to FIG. 4, a block diagram of a multimedia system in accordance with other preferred embodiment of the present invention is shown. In this exemplary embodiment, the network monitoring image capture module 410 of the multimedia system 40 transmits the electronic signals under internet protocol. Thus, a radio-signal receiver 430 is needed to transmit the electronic signal to the signal converter 400. Of course, it is well known that the radio-signal receiver 430 may be arranged in the signal converter 400.

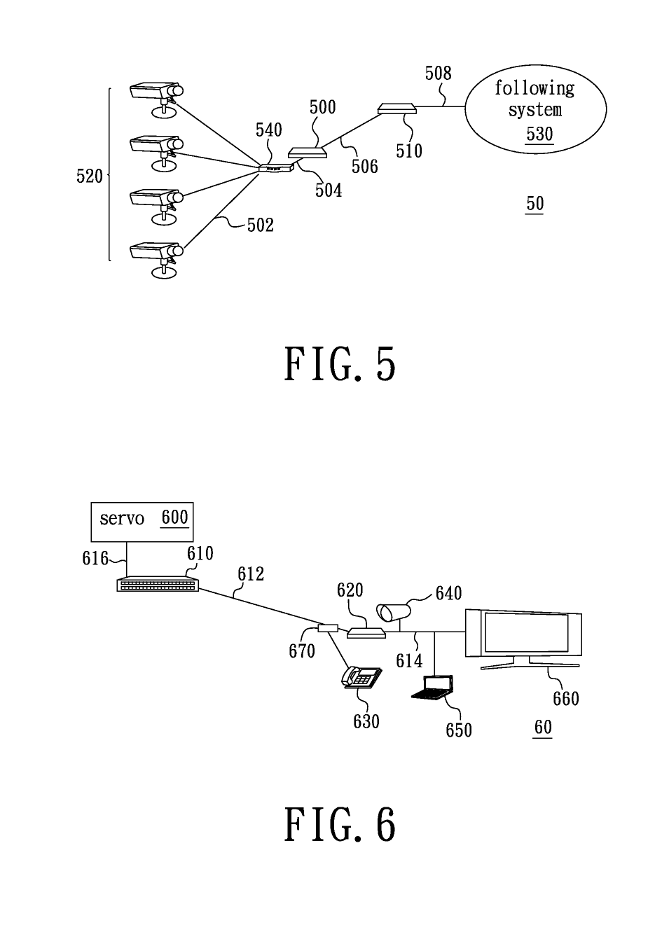

Referring to FIG. 5, a block diagram of a multimedia system in accordance with other preferred embodiment of the present invention is shown. The multimedia system 50 is similar to those of the above embodiments, except that the multimedia system 50 includes conventional image capture module 520. The conventional image capture devices of the image capture module 520 output analog signals instead of digital signals. A Multimedia interface device 540 is arranged between the image capture module 520 and signal converter 500 for making the signal converter 500 effectively receive the image signals from the image capture module 520. The Multimedia interface device 540 may be a video/audio server, or a computer having a TV card and a network card. The multimedia interface device 540 may receive the analog electronic signals from the image capture module 520 through the transmission medium 502 (such as cables), convert the analog electronic signals, and transmit them to the signal converter 500 through the transmission medium 504 (such as network lines). Similarly, the electronic signals modulated by the signal converter 500 are transmitted to another signal converter 510 through the transmission medium 506, and transmitted to a rear system 530 through the transmission medium 508 after being demodulated.

Therefore, the above old hard device can cooperate with the signal converter to combine a modern multimedia, thus the old hard device may extend its working-life, and save the cost.

Referring to FIG. 6, a block diagram of a multimedia system in accordance with other preferred embodiment of the present invention is shown. The multimedia system 60 includes a server 600, two signal converters 610 and 620, a telephone 630, an image capture device 640, a computer 650 and a display device 660. The server 600 is configured for storing the multimedia information, and supplying the multimedia information to the signal converter 610 through a transmission medium 616 (usually be new network lines). The signal converter 610 modulates the multimedia information by the orthogonal frequency-division multiplexing (OFDM) technology, and transmits the modulated multimedia information to the signal converter 620 through a transmission medium 612 (similar to the old transmission medium, such as telephone lines, coaxial cables or twisted pairwires). The display device 660 displays the multimedia information demodulated by the signal converter 620 through the transmission medium 614 (usually be new network lines).

In this exemplary embodiment, the telephone 630 may use the transmission medium 612 with other devices of the multimedia system 60 through a frequency-divider 670. The image capture device 640 and the computer can transmit the information to the server 600 or other rear system by the methods described in the above.

In order to achieve a good network service, the server 600 can be arranged on a fiber network. The transmission medium of the signal converter 610, which corresponds to the server 600, must be communicated with the fiber network. That is, the signal converter 610 must have a hard device, which can process the fiber interface. Or the hard device, which can process the fiber interface, must be coupled between the signal converter 610 and the transmission medium 616 (the fiber) to convert signal/interface.

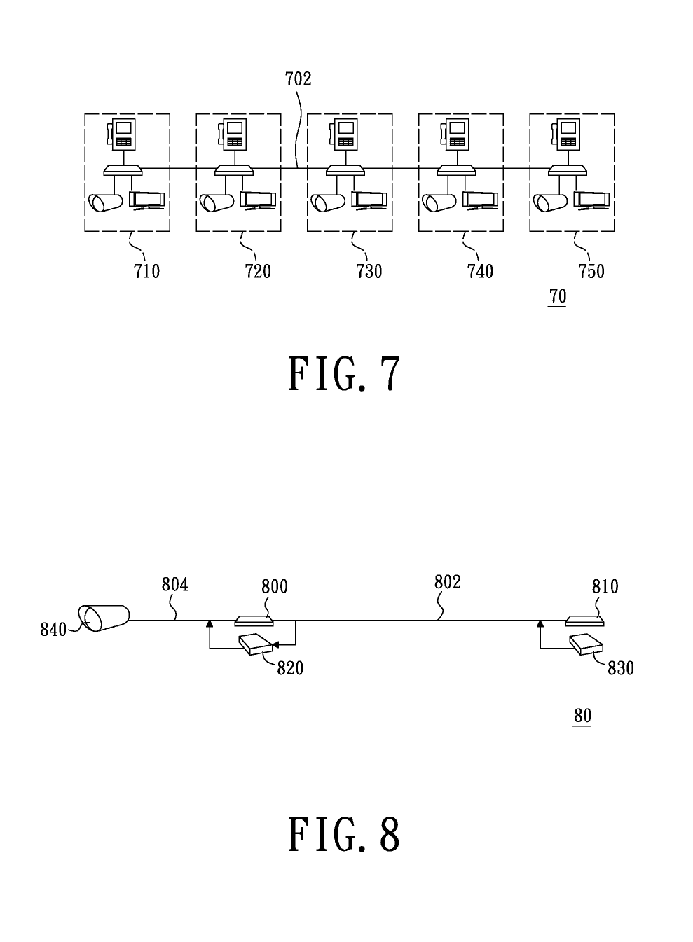

Referring to FIG. 7, a block diagram of a multimedia system in accordance with other preferred embodiment of the present invention is shown. In this exemplary embodiment, the multimedia system 70 includes a plurality of multimedia modules 710, 720, 730, 740 and 750. The plurality of multimedia modules are communicated through transmission media 702 (including but not limited the telephone lines, coaxial cables, or twisted pairwires) for transmitting the signals. Each multimedia module operates similarly to the above. It should be noted that, since old trains have basal telephone lines set therein, the multimedia system supplied in the old trains may further includes a server 600 as shown in FIG. 6 to enhance its functions, such as supplying corresponding presentation when passing through various locations, which will be an excellent service for passengers. Furthermore, the similar frame may be used in the elevator. Usually, the elevator has a lash-up telephone therein, and the multimedia system 70 can be used by using the telephone lines of the lash-up telephone.

For making the above multimedia system used widely, the locations difficult setting power lines therein, can use directly the power of the transmission medium. Referring to FIG. 8, a block diagram of a multimedia system in accordance with other preferred embodiment of the present invention is shown. In this exemplary embodiment, the multimedia system 80 employs a power converter 830 to supply the power on the transmission medium 802 between the signal converters 800 and 810. The power can be converted another power for the image capture device 840 after passing through another power converter 820, and supplied to the image capture device 840 through the transmission medium 804. Of course, if the transmission medium 802 is a device, which can supply the power, for example, the present used telephone lines has the power therein, and the power converter 830 does not be needed to supply the power.

From the above, the present invention can effectively reduce the cost and time for set the multimedia system (including the monitoring system). Furthermore the present multimedia system can be used directly in the old system, thus the old system can extend its working-life and fit the modern society.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A multimedia system using signal converters, comprising:
an image capture device, configured for capturing images, converting the captured images into a first electronic signal, and transmitting the first electronic signal through a first type transmission interface;
a first signal converter, configured for receiving the first electronic signal, modulating the first electronic signal by an orthogonal frequency-division multiplexing (OFDM) technology to obtain a second electronic signal adapted for a second type transmission interface; and
a second signal converter, configured for receiving and modulating the second electronic signal through the second type transmission interface, wherein the first type transmission interface is different from the second type transmission interface.

2. The multimedia system as claimed in claim 1, wherein the first type transmission interface uses RJ-45 lines as a transmission medium.

3. The multimedia system as claimed in claim 1, wherein the first type transmission interface uses a wireless network protocol.

4. The multimedia system as claimed in claim 3, further comprising a radio-signal receiver, configured for receiving the first electronic signal and transmitting the first electronic signal to the first signal converter.

5. The multimedia system as claimed n claim 1, wherein the second type transmission interface uses coaxial cables as a transmission medium.

6. The multimedia system as claimed n claim 1, wherein the second type transmission interface uses telephone lines as a transmission medium.

7. The multimedia system as claimed n claim 1, wherein the second type transmission interface uses twisted pairwires as a transmission medium.

8. The multimedia system as claimed n claim 1, wherein power of the image capture device is supplied through a transmission medium used in the second type transmission interface.

9. The multimedia system as claimed in claim 8, further comprising a power converter, configured for converting the power on the transmission medium of the second type transmission interface to a power adapted for the image capture device.

10. The multimedia system as claimed in claim 1, further comprising a display device, configured for receiving and displaying the modulated second electronic signal.

11. The multimedia system as claimed in claim 1, wherein the first signal converter is capable of receiving a plurality of first electronic signals sent from a plurality of the image capture devices.

12. The multimedia system as claimed in claim 1, wherein the image capture device comprises a network monitoring image capture device.

13. The multimedia system as claimed in claim 1, further comprising a multimedia interface device coupled between the image capture device and the first signal converter, the multimedia interface device being configured for converting the first electronic signal sent from the image capture device to an electronic signal suited for the first signal converter.

14. The multimedia system as claimed in claim 13, wherein the image capture device comprises a conventional image capture device.

15. A signal converter, comprising:
a first transmission interface and a second transmission interface, a first electronic signal adapted for the first transmission interface and a second electronic signal adapted for the second transmission interface being modulated/demodulated by an orthogonal frequency-division multiplexing (OFDM) technology, wherein the first transmission interface is configured for exchanging information with one of an image capture device, a display device and a network telephone, and the second type transmission interface uses one of coaxial cables, telephone lines and twisted pairwires as a transmission medium.

16. The signal converter as claimed in claim 15, wherein the first type transmission interface uses RJ-45 lines as a transmission medium.

17. A multimedia system using signal converters, comprising:
a server, configured for supplying multimedia information;
a first signal converter, configured for receiving the multimedia information through a first type transmission interface, and modulating the multimedia information to obtain an electronic signal suited for a second type transmission interface;
a second signal converter, configured for receiving and demodulating the electronic signal through the second type transmission interface; and
a display device electrically connecting to the second signal converter to display the electronic signal after being demodulated by the second signal converter,
wherein the first type transmission interface is different from the second type transmission interface.

18. The multimedia system as claimed in claim 17, wherein the second type transmission interface uses coaxial cables as a transmission medium.

19. The multimedia system as claimed in claim 17, wherein the second type transmission interface uses telephone lines as a transmission medium.

20. The multimedia system as claimed in claim 17, wherein the second type transmission interface uses twisted pairwires as a transmission medium.
